(19) United States
(12) Patent Application Publication
(10) Pub. No.: US 2024/0030791 A1
(43) Pub. Date: Jan. 25, 2024

(54) MAGNETIZING APPARATUS, MAGNETIZING METHOD, ROTOR, MOTOR, COMPRESSOR, AND REFRIGERATION CYCLE APPARATUS

(71) Applicant: Mitsubishi Electric Corporation, Tokyo (JP)

(72) Inventors: Atsushi ISHIKAWA, Tokyo (JP); Atsushi MATSUOKA, Tokyo (JP)

(21) Appl. No.: 18/255,121

(22) PCT Filed: Jan. 19, 2021
(86) PCT No.: PCT/JP2021/001666

§ 371 Date: May 31, 2023

(51) Int. Cl. H02K 15/03

(52) U.S. Cl. CPC H02K 15/03; H02K 2215/00

(57) ABSTRACT

A magnetizing apparatus is to magnetize a permanent magnet of a motor. The motor includes an annular stator mounted to an inner side of a compressor shell and having a winding, and a rotor provided on an inner side of the stator and having the permanent magnets. The magnetizing apparatus includes an outer circumferential yoke detachably mounted to an outer side of the compressor shell and being made of a magnetic material, and a power supply device applying a magnetization current to the winding of the stator.

This application is a U.S. national stage application of International Patent Application No. PCT/JP2021/001666 filed on Jan. 19, 2021, the disclosure of which is incorporated herein by reference.

### TECHNICAL FIELD

The present disclosure relates to a magnetizing apparatus, a magnetizing method, a rotor, a motor, a compressor, and a refrigeration cycle apparatus.

### BACKGROUND

There is a known method of magnetizing a permanent magnet in a motor. In the known method, a permanent magnet before magnetization is embedded in a motor and is magnetized by applying a magnetization current to a winding of the motor. Such a magnetizing method is called built-in magnetization.

In the case of a motor used in a compressor, it is desirable to magnetize the permanent magnet in a state where the motor is incorporated in the compressor. Thus, there is a proposed method, in which a dedicated magnetization external yoke is mounted to the outside of the compressor in which the motor is incorporated, and a magnetization current is applied to coils of the magnetization external yoke to magnetize the permanent magnet (see, for example, Patent Reference 1).

### PATENT REFERENCE

Patent Reference 1: Japanese Patent Application Publication No. 11-252874 (see FIG. 1)

However, there is a case where the magnetization external yoke interferes with peripheral components such as a refrigerant pipe of the compressor and cannot be mounted to the compressor.

### SUMMARY

An object of the present disclosure is to enable magnetization of a permanent magnet of a motor inside a compressor without interfering with peripheral components of the compressor.

A magnetizing apparatus according to the present disclosure is an apparatus to magnetize a permanent magnet of a motor. The motor includes an annular stator mounted to an inner side of a compressor shell and having a winding, and a rotor provided on an inner side of the stator and having the permanent magnet. The magnetizing apparatus includes an outer circumferential yoke detachably mounted to an outer side of the compressor shell and being made of a magnetic material, and a power supply device applying a magnetization current to the winding of the stator. The outer circumferential yoke is shaped to surround the compressor shell, and has a cutout portion at one location in a circumferential direction about a rotation axis of the rotor.

A magnetizing method according to the present disclosure is a method of magnetizing a permanent magnet of a motor. The motor includes an annular stator mounted to an inner side of a compressor shell and having a winding, and a rotor provided on an inner side of the stator and having the permanent magnet. The magnetizing method includes mounting an outer circumferential yoke made of a magnetic material to an outer side of the compressor shell, applying a magnetization current from a power supply device to the winding of the stator, and detaching the outer circumferential yoke from the compressor shell. The outer circumferential yoke is shaped to surround the compressor shell, and has a cutout portion at one location in a circumferential direction about a rotation axis of the rotor.

A rotor according to the present disclosure is a rotor of a motor. The motor includes an annular stator mounted to an inner side of a compressor shell and having a winding, and a rotor provided on an inner side of the stator and having the permanent magnet. The permanent magnet is magnetized by mounting an outer circumferential yoke made of a magnetic material to an outer side of the compressor shell, applying a magnetization current from a power supply device to the winding of the stator, and detaching the outer circumferential yoke from the compressor shell. The outer circumferential yoke is shaped to surround the compressor shell, and has a cutout portion at one location in a circumferential direction about a rotation axis of the rotor.

According to the present disclosure, the magnetization of the permanent magnet can be performed while mounting the outer circumferential yoke to the compressor shell and applying the magnetization current to the winding of the stator. After the magnetization of the permanent magnet, the outer circumferential yoke can be detached from the compressor shell. Therefore, the permanent magnet of the motor inside the compressor can be magnetized without interfering with peripheral components of the compressor.

### BRIEF DESCRIPTION OF THE DRAWINGS

FIG. 1 is a cross-sectional view illustrating a motor of a first embodiment.

FIG. 2 is a diagram illustrating a part of a stator core of the motor of the first embodiment.

FIG. 3 is a diagram illustrating a magnetizing apparatus of the first embodiment.

FIG. 4 is a cross-sectional view illustrating the motor, a compressor shell, and an outer circumferential yoke of the first embodiment.

FIG. 5(A) is a diagram illustrating a configuration of the magnetizing apparatus of the first embodiment, and FIG. 5(B) is a diagram illustrating a magnetization current in the first embodiment.

FIGS. 6(A) and 6(B) are a perspective view and a partially cutaway perspective view illustrating a compressor of the first embodiment, respectively.

FIG. 7 is a flowchart illustrating a magnetizing method of the first embodiment.

FIGS. 8(A) and 8(B) are schematic diagrams illustrating forces acting on windings in a magnetizing step.

FIG. 9(A) is a diagram illustrating a magnetizing yoke of Comparative Example 1, and FIG. 9(B) is a diagram illustrating a magnetizing apparatus of Comparative Example 1.

FIG. 10 is a diagram illustrating a magnetizing apparatus of Comparative Example 2.

FIG. 11 is a diagram illustrating the flow of magnetic flux in a magnetizing step using the magnetizing apparatus of Comparative Example 2.

FIG. 12 is a diagram illustrating the flow of magnetic flux in a magnetizing step using the magnetizing apparatus of the first embodiment.

FIG. 13 is a graph illustrating the relationship between a magnetomotive force and a magnetization ratio for each of the first embodiment and Comparative Example 2.

FIGS. 14(A) and 14(B) are a side view and a cross-sectional view illustrating a compressor and an outer circumferential yoke of a second embodiment.

FIGS. 15(A) and 15(B) are a perspective view and a partially cutaway perspective view illustrating a compressor and an outer circumferential yoke of a third embodiment, respectively.

FIGS. 16(A) and 16(B) are cross-sectional views illustrating the compressor and the outer circumferential yoke of the third embodiment.

FIGS. 17(A) and 17(B) are cross-sectional views illustrating a compressor and an outer circumferential yoke of a fourth embodiment.

FIG. 18 is a diagram illustrating the flow of magnetic flux in the compressor and the outer circumferential yoke of the fourth embodiment.

FIG. 19 is a graph illustrating the relationship between a magnetomotive force and a magnetization ratio for each of the first and fourth embodiments and Comparative Example 2.

FIG. 20 is a graph illustrating the relationship between an opening angle of a cutout portion of the outer circumferential yoke and a magnetomotive force required to achieve a magnetization ratio of 99.5% in the fourth embodiment.

FIGS. 21(A) and 21(B) are cross-sectional views illustrating the compressor and the outer circumferential yoke of the fourth embodiment.

FIG. 22 is a graph illustrating the relationship between the position in the circumferential direction of the cutout portion of the outer circumferential yoke and a magnetomotive force required to achieve a magnetization ratio of 99.5% in the fourth embodiment.

FIG. 23 is a diagram illustrating an example of using the magnetizing apparatus of each embodiment as a demagnetizing apparatus.

FIG. 24 is a diagram illustrating a demagnetization current waveform used in the demagnetizing apparatus illustrated in FIG. 23.

FIG. 25 is a diagram illustrating a compressor to which the motor of each embodiment is applicable.

FIG. 26 is a diagram illustrating a refrigeration cycle apparatus including the compressor illustrated in FIG. 25.

### DETAILED DESCRIPTION

### First Embodiment

### (Configuration of Motor)

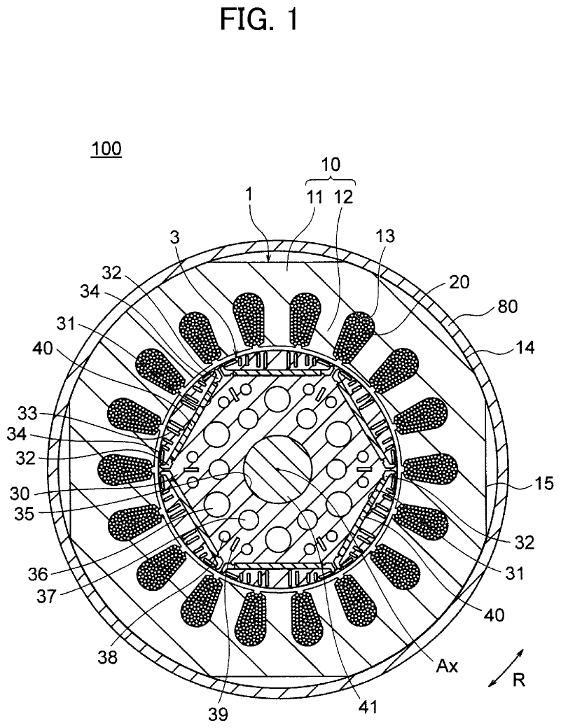

FIG. 1 is a cross-sectional view illustrating a motor 100 of a first embodiment. The motor 100 of the first embodiment includes a rotor 3 that is rotatable and a stator 1 that surrounds the rotor 3. An air gap of 0.25 to 1.25 mm is provided between the stator 1 and the rotor 3.

Hereinafter, the direction of an axis Ax, which is a rotation axis of the rotor 3, is referred to as an “axial direction”. The circumferential direction about the axis Ax is referred to as a “circumferential direction” and indicated by an arrow R in FIG. 1 and other figures. The radial direction about the axis Ax is referred to as a “radial direction”. FIG. 1 illustrates a cross-section orthogonal to the axial direction.

The rotor 3 has a rotor core 30 and permanent magnets 40 mounted to the rotor core 30. The rotor core 30 has a cylindrical shape about the axis Ax. The rotor core 30 is formed of electromagnetic steel sheets which are stacked in the axial direction and fixed integrally by crimping, rivets, or the like. Each electromagnetic steel sheet has a sheet thickness of, for example, 0.1 to 0.7 mm.

The rotor core 30 has a plurality of magnet insertion holes 31 along its outer circumference. In this example, six magnet insertion holes 31 are arranged at equal intervals in the circumferential direction. One permanent magnet 40 is arranged in each magnet insertion hole 31.

Each permanent magnet 40 forms one magnetic pole. Since the number of permanent magnets 40 is six, the number of poles of the rotor 3 is six. Incidentally, the number of poles of the rotor 3 is not limited to six and only needs to be two or more. Two or more permanent magnets 40 may be arranged in one magnet insertion hole 31 to constitute one magnetic pole. The center of each magnet insertion hole 31 in the circumferential direction is a pole center. An inter-pole portion is formed between adjacent magnet insertion holes 31.

The permanent magnet 40 is a flat plate-shaped member that has a width in the circumferential direction and a thickness in the radial direction. The permanent magnet 40 is made of a rare earth sintered magnet that contains neodymium (Nd), iron (Fe) and boron (B). The permanent magnet 40 is magnetized in its thickness direction, i.e., the radial direction. The permanent magnets 40 adjacent to each other in the circumferential direction have magnetization directions opposite to each other.

The rotor core 30 has a circular shaft hole 35 formed at its center in the radial direction. A shaft 41 is fixed to the shaft hole 35 by press-fitting. The center axis of the shaft 41 coincides with the axis Ax described above.

A flux barrier 32 is formed on each of both ends of the magnet insertion hole 31 in the circumferential direction. The flux barrier 32 is an opening extending in the radial direction toward the outer circumference of the rotor core 30 from an end of the magnet insertion hole 31 in the circumferential direction. The flux barrier 32 is provided to suppress the leakage magnetic flux between the adjacent magnetic poles.

Slits 33 are formed on the outer side of the magnet insertion hole 31 in the radial direction. In this example, eight slits 33, each being elongated in the radial direction, are formed symmetrically with respect to the pole center. Slit 34 that are elongated in the circumferential direction are formed on both sides of a group of the eight slits 33 in the circumferential direction. In this regard, the number and positions of the slits 33 are not limited, and the number and positions of the slits 34 are not limited. The rotor core 30 may be configured to have none of the slits 33 and 34.

Crimping portions 39 for integrally fixing the electromagnetic steel sheets constituting the rotor core 30 are formed on the inner side of the inter-pole portions in the radial direction. Incidentally, positions of the crimping portions 39 are not limited to these positions.

A through hole 36 is formed on the inner side of the magnet insertion hole 31 in the radial direction, and a through hole 37 is formed on the inner side of the crimping portion 39 in the radial direction. Through holes 38 are formed on both sides of the crimping portion 39 in the circumferential direction. Each of the through holes 36, 37, and 38 extends from one end to the other end of the rotor core 30 in the axial direction and is used as a refrigerant flow path or a rivet hole. Positions of the through holes 36, 37, and 38 are not limited to these positions. The rotor core 30 may be configured to have none of the through holes 36, 37 and 38.

The stator 1 has a stator core 10 and windings 20 wound on the stator core 10. The stator core 10 has an annular shape about the axis Ax. The stator core 10 is formed of a plurality of electromagnetic steel sheets which are stacked in the axial direction and integrally fixed by crimping or the like. Each electromagnetic steel sheet has a thickness of, for example, 0.1 to 0.7 mm.

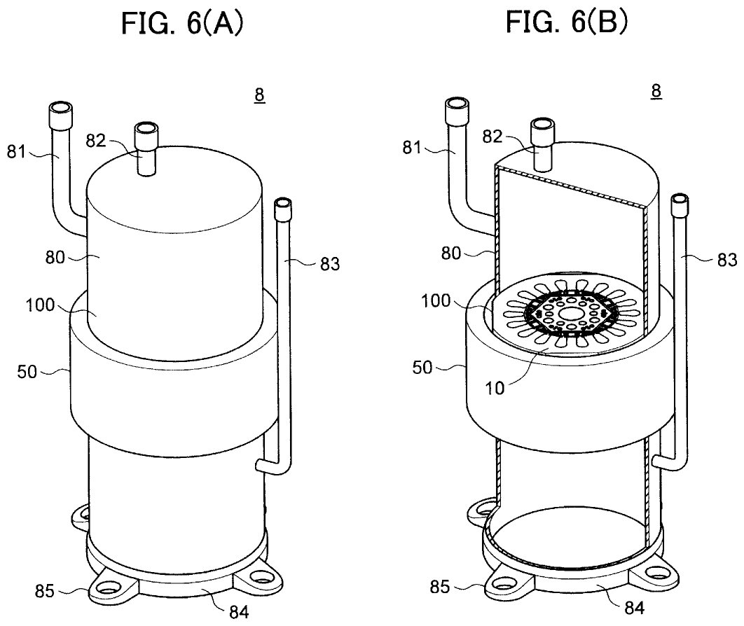

The stator core 10 has an annular core back 11 and a plurality of teeth 12 extending inward in the radial direction from the core back 11. The core back 11 has an outer circumferential surface 14 having a circular shape about the axis Ax. The outer circumferential surface 14 of the core back 11 is fitted to an inner circumferential surface of a cylindrical compressor shell 80. The compressor shell 80 is a part of a compressor 8 (FIG. 6(A)) and formed of a magnetic material such as a steel sheet.

The teeth 12 are formed at equal intervals in the circumferential direction. A slot 13 is formed between adjacent teeth 12. The winding 20 is wound around the tooth 12. The number of teeth 12 is 18 in this example, but only needs to be two or more.

D-cut portions 15, each of which is a planer portion parallel to the axis Ax, are formed on the outer circumferential surface 14 of the core back 11. Each D-cut portion 15 extends from one end to the other end of the stator core 10 in the axial direction.

The D-cut portions 15 are formed at four locations at intervals of 90 degrees about the axis Ax. Incidentally, the number and positions of the D-cut portions 15 are not limited to these examples. A gap is formed between the D-cut portion 15 and the inner circumferential surface of the compressor shell 80. This gap serves as a flow path through which a refrigerant flows in the axial direction.

The winding 20 includes a conductor made of aluminum or copper and an insulating cover film covering the conductor. The winding 20 is wound around the tooth 12 in a distributed winding. However, the winding method of the winding 20 is not limited to the distributed winding, but may also be a concentrated winding.

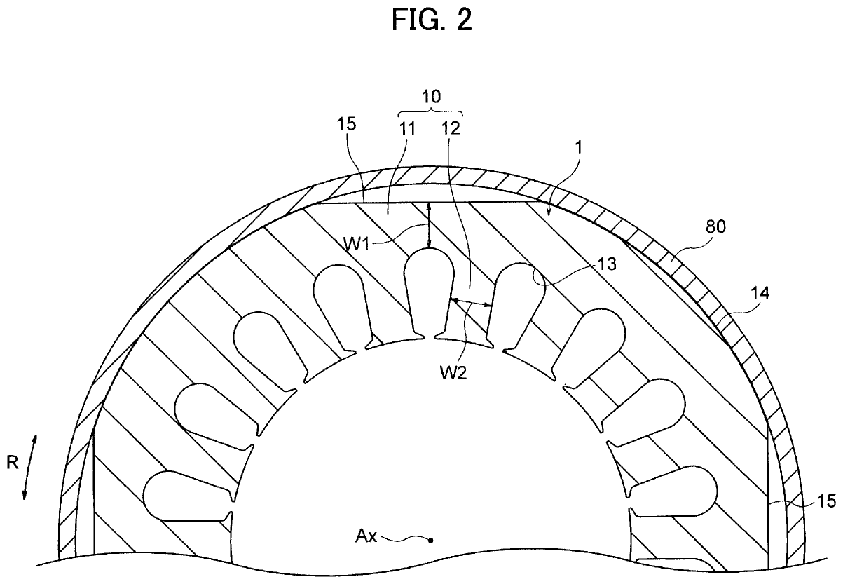

FIG. 2 is an enlarged diagram illustrating the stator core 10. A tooth tip portion that is wide in the circumferential direction is formed at the tip of the tooth 12 on an inner side in the radial direction. The tooth tip portion of the tooth 12 faces an outer circumferential surface of the rotor 3. A width W2 of the tooth 12 in the circumferential direction is constant except for the tooth tip portion.

The slot 13 is formed between adjacent teeth 12. The number of slots 13 is the same as the number of teeth 12 (in this example, 18). The winding 20 wound around the tooth 12 is housed in the slot 13. The minimum width W1 of the core back 11 is the shortest distance from the slot 13 to the D-cut portion 15.

### (Magnetizing Apparatus)

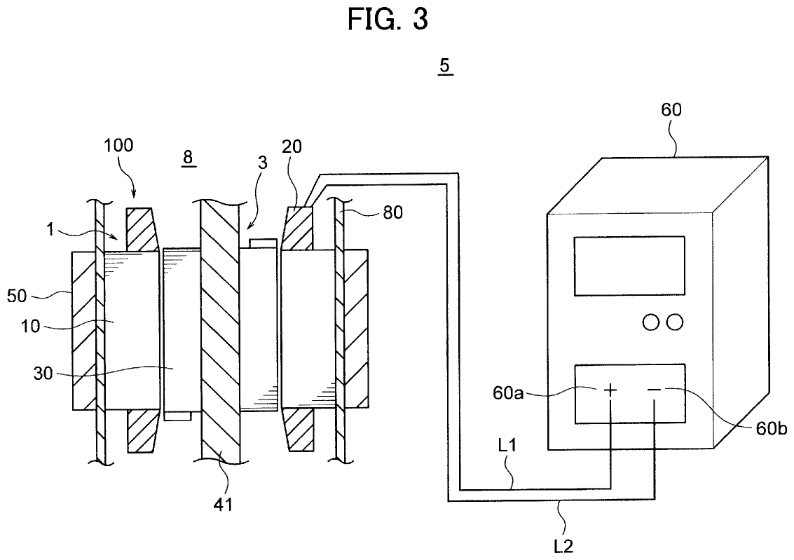

FIG. 3 is a diagram illustrating a magnetizing apparatus 5 for magnetizing the permanent magnets 40. In the first embodiment, the rotor 3 having the permanent magnets 40 before magnetization is incorporated in the stator 1 to constitute the motor 100, and the permanent magnets 40 are magnetized in a state where the motor 100 is incorporated in the compressor 8 (FIG. 6(A)).

As illustrated in FIG. 3, the magnetizing apparatus 5 includes an outer circumferential yoke 50 mounted to an outer side of the compressor shell 80, and a power supply device 60. The outer circumferential yoke 50 is a circular ring-shaped member made of a magnetic material. The length of the outer circumferential yoke 50 in the axial direction is longer than or equal to the length of the stator core 10 in the axial direction, and is the same as the length of the stator core 10 in the axial direction in this example. The center of the outer circumferential yoke 50 in the axial direction is located at the same height as the center of the stator core 10 in the axial direction.

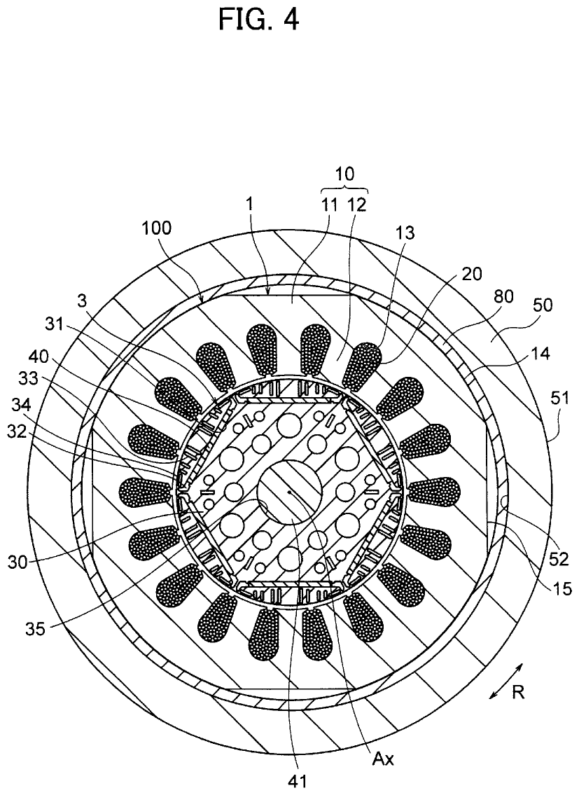

FIG. 4 is a cross-sectional view illustrating the motor 100, the compressor shell 80, and the outer circumferential yoke 50. The outer circumferential yoke 50 is formed of a stacking body in which a plurality of electromagnetic steel sheets are stacked in the axial direction. The sheet thickness of each electromagnetic steel sheet may be the same as the sheet thickness of the electromagnetic steel sheet of the stator core 10 or may be thicker than the sheet thickness of the electromagnetic steel sheet of the stator core 10.

The outer circumferential yoke 50 is not limited to the stacking body of the electromagnetic steel sheets, but may be formed of, for example, a bulk body of a magnetic material. However, the outer circumferential yoke 50 formed of the stacking body of the electromagnetic steel sheets is more advantageous since generation of eddy current when a magnetizing magnetic flux flows therein can be suppressed.

The outer circumferential yoke 50 has an outer circumferential surface 51 and an inner circumferential surface 52. Each of the outer and inner circumferential surfaces 51 and 52 is circular about the axis Ax. It is desirable that the inner circumferential surface 52 of the outer circumferential yoke 50 is in contact with the outer circumferential surface of the compressor shell 80. In particular, it is desirable that the entire area of the inner circumferential surface 52 of the outer circumferential yoke 50 in the circumferential direction is in contact with the outer circumferential surface of the compressor shell 80.

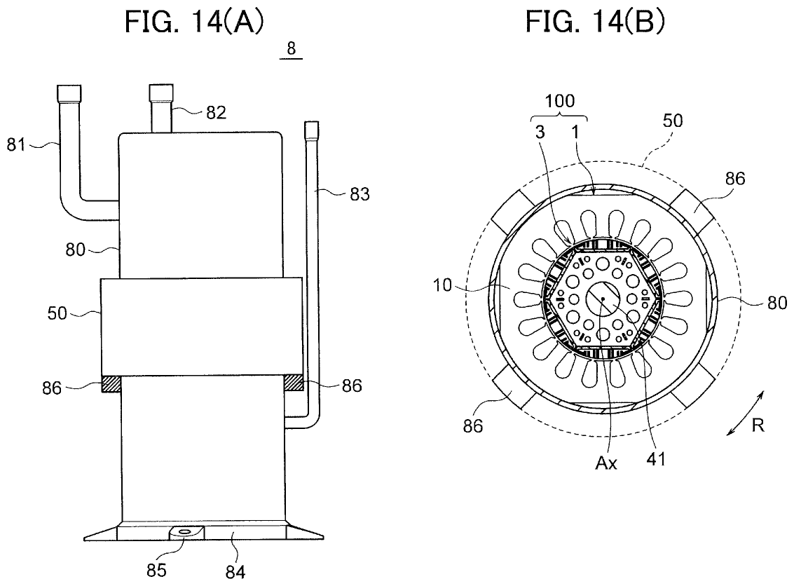

The outer circumferential yoke 50 is fixed to the compressor shell 80 by a frictional force between its inner circumferential surface 52 and the outer circumferential surface of the compressor shell 80. As described in a second embodiment, the compressor shell 80 may be provided with convex portions 86 (FIG. 14(A)) for positioning the outer circumferential yoke 50.

In an example illustrated in FIG. 4, the width of the outer circumferential yoke 50 in the radial direction is wider than the minimum width W1 (FIG. 2) of the core back 11. Incidentally, the effect of reducing magnetic saturation (described later) can be achieved to some extent even when the width of the outer circumferential yoke 50 in the radial direction is narrow.

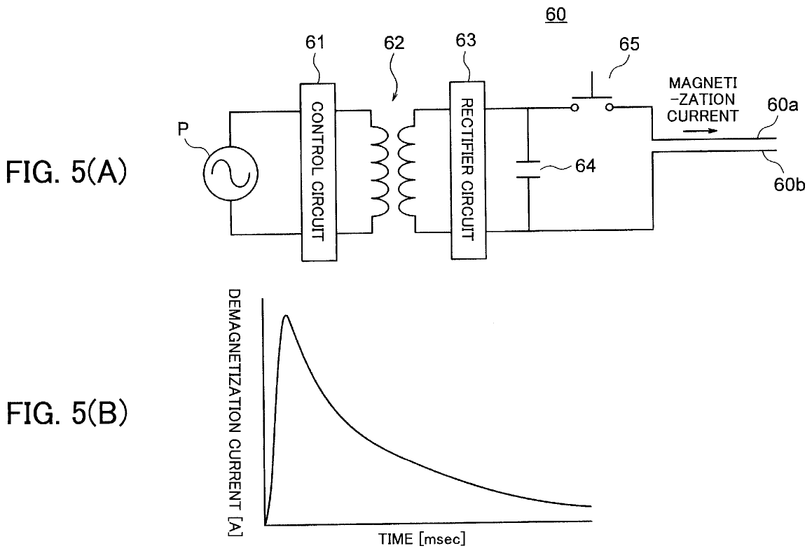

FIG. 5(A) is a diagram illustrating the configuration of the power supply device 60. The power supply device 60 has a control circuit 61, a booster circuit 62, a rectifier circuit 63, a capacitor 64, and a switch 65.

The control circuit 61 controls the phase of an AC voltage supplied from an AC power supply P. The booster circuit 62 boosts an output voltage of the control circuit 61. The rectifier circuit 63 converts the AC voltage into a DC voltage. The capacitor 64 accumulates electric charge. The switch 65 is a switch for discharging the electric charge accumulated in the capacitor 64. Output terminals 60a and 60b (FIG. 3) of the power supply device 60 are connected to the windings 20 of the stator 1 via wires L1 and L2.

The waveform of the magnetization current output from the power supply device 60 to the windings 20 has a high peak of, for example, several kA immediately after the switch 65 is turned ON, as illustrated in FIG. 5(B).

### (Magnetizing Method)

Next, the magnetizing method of the first embodiment will be described. The magnetization of the permanent magnets 40 is performed in a state where the motor 100 is incorporated inside the compressor shell 80 of the compressor 8 and the outer circumferential yoke 50 is mounted to the outside of the compressor shell 80.

FIGS. 6(A) and 6(B) are a perspective view and a partially cutaway perspective view, respectively, illustrating a state in which the motor 100 is incorporated inside the compressor shell 80 and the outer circumferential yoke 50 is mounted to the outside of the compressor shell 80. As illustrated in FIG. 6(B), the outer circumferential yoke 50 is located on the outer side of the stator core 10 in the radial direction.

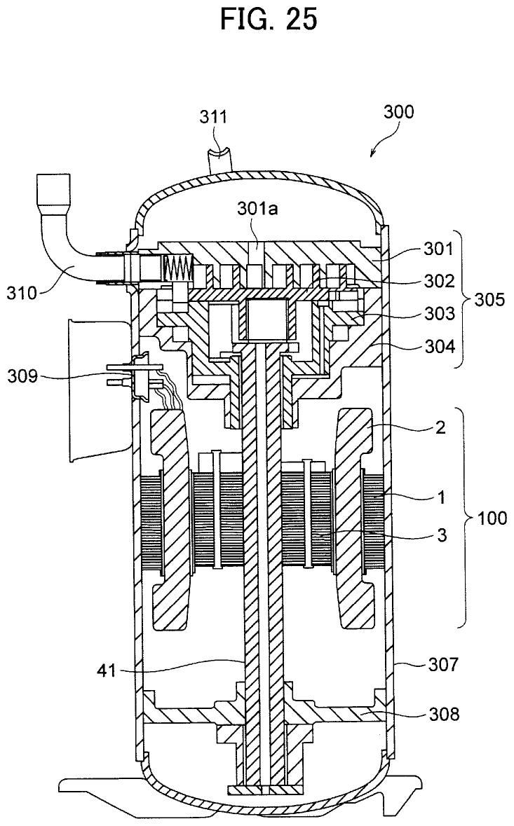

The compressor 8 has the motor 100 and a compression mechanism inside the compressor shell 80. The compressor shell 80 is a cylindrical container. In this example, the axial direction of the compressor shell 80 coincides with the vertical direction. The compressor shell 80 has mounting legs 85 at a bottom 84 thereof. At the mounting legs 85, the compressor shell 80 is fixed to, for example, an outdoor unit of an air conditioner. The compression mechanism is omitted in FIGS. 6(A) and 6(B). An example of a specific structure of the compressor 8 will be described later with reference to FIG. 25.

A suction pipe 81, a discharge pipe 82, and an oil pipe 83 are attached to the compressor shell 80. The suction pipe 81 is attached to an upper portion of the outer circumferential surface of the compressor shell 80, and the discharge pipe 82 is attached to a top surface of the compressor shell 80. The oil pipe 83 is attached to a lower portion of the outer circumferential surface of the compressor shell 80. The suction pipe 81, the discharge pipe 82, and the oil pipe 83 are collectively referred to as the pipes 81, 82, and 83.

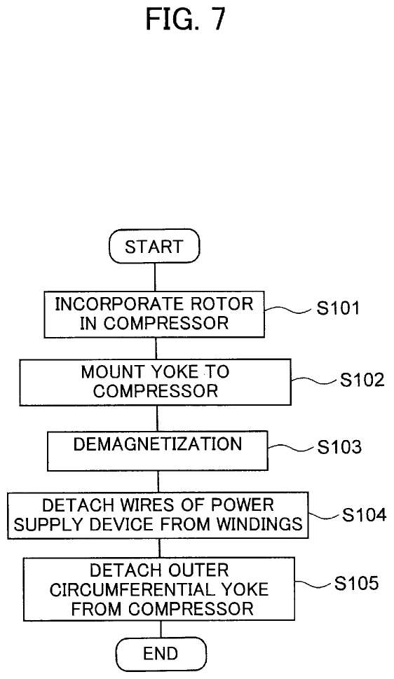

FIG. 7 is a flowchart illustrating a magnetization step of the first embodiment. First, the rotor 3 having the permanent magnets 40 before magnetization is incorporated in the stator 1 to constitute the motor 100, and then the motor 100 is incorporated in the compressor shell 80 (step S101). The incorporation of the motor 100 into the compressor shell 80 is performed, for example, by shrink-fitting or press-fitting. In the first embodiment, the suction pipe 81 (FIG. 6(A)) is attached to the compressor shell 80 after the magnetizing step.

Next, the outer circumferential yoke 50 is mounted to the outer side of the compressor shell 80 (step S102). The outer circumferential yoke 50 is mounted to the compressor shell 80 by being slid from above the compressor shell 80, and is fixed to the compressor shell 80 by friction between the inner circumferential surface of the outer circumferential yoke 50 and the outer circumferential surface of the compressor shell 80. In order to match the height of the outer circumferential yoke 50 to the height of the stator core 10, marking may be applied to the outer circumferential surface of the compressor shell 80 in advance.

In this state, the wires L1 and L2 connected to the terminals 60a and 60b of the power supply device 60 are connected to the windings 20 of the stator 1, and the magnetization current (FIG. 5(B)) is applied to the windings 20 by the power supply device 60 (step S103).

By applying the magnetization current to the windings 20, the magnetizing magnetic field is generated in proportion to the magnetization current. Due to this magnetizing magnetic field, the magnetizing magnetic flux flows through the stator core 10 and the rotor core 30. The magnetizing magnetic flux flows to the permanent magnets 40, thereby magnetizing the permanent magnets 40.

When the magnetization of the permanent magnets 40 is completed, the wires L1 and L2 of the power supply device 60 are detached from the windings 20 of the motor 100 (step S104). Thereafter, the outer circumferential yoke 50 is slid in the axial direction and detached from the compressor shell 80 (step S105). In this way, the magnetizing step illustrated in FIG. 7 is completed.

### (Lorentz Force Caused by Magnetization Current)

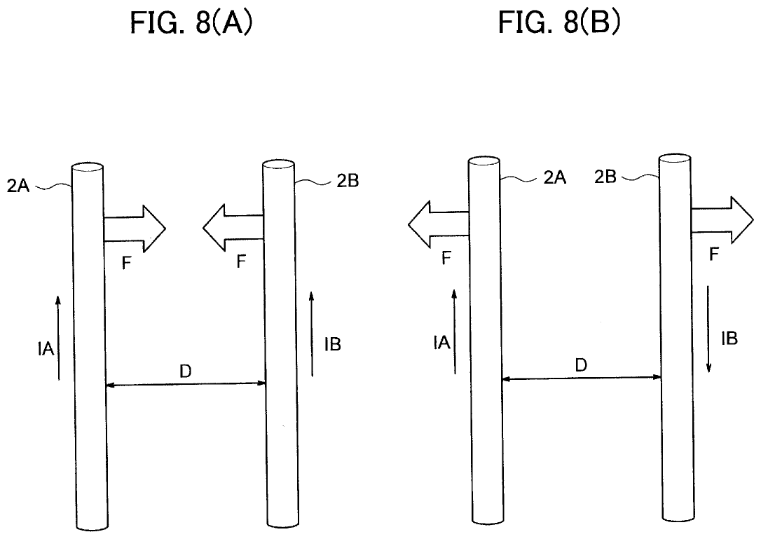

Next, the Lorentz force generated in the windings 20 in step S103 will be described. FIGS. 8(A) and 8(B) are schematic diagrams illustrating a generation principle of the Lorentz force. In this example, two conductors 2A and 2B are arranged in parallel, and a current IA [A] flows to the conductor 2A while a current IB [A] flows to the conductor 2B. A distance between the conductors 2A and 2B is defined as D [m].

The Lorentz force F per unit length [N/m], expressed by the following formula (1), acts on the conductors 2A and 2B.

F=μ₀×IA×IB/(2π×D) (1)

where μ₀ is a magnetic permeability of the vacuum, and μ₀=4π×10⁻⁷ [H/m].

When the current IA and the current IB flow in the same direction as illustrated in FIG. 8(A), the Lorentz force acts on the conductors 2A and 2B in the direction in which the conductors 2A and 2B are attracted to each other. On the other hand, when the current IA and the current IB flow in the opposite directions as illustrated in FIG. 8(B), the Lorentz force acts on the conductors 2A and 2B in the direction in which the conductors 2A and 2B are repulsed from each other.

Such a Lorentz force acts on the windings 20 instantaneously during magnetization, which may damage or deform the conductor of the windings 20, or may cause insulation failure due to damage to a cover film covering the conductor.

The formula (1) shows that the Lorentz force can be reduced by increasing the distance D between the conductors 2A and 2B or by decreasing the current IA or IB. However, if the distance D between the conductors 2A and 2B is increased, an interval between the adjacent windings 20 increases. This leads to a decrease in the space factor in the slot 13 or an increase in the circumferential length of the winding 20. Thus, it is not practical to increase the distance D. For this reason, it is desired to reduce the current IA or IB, in other words, the magnetization current that flows through the winding 20 to a lower level.

### Comparative Example

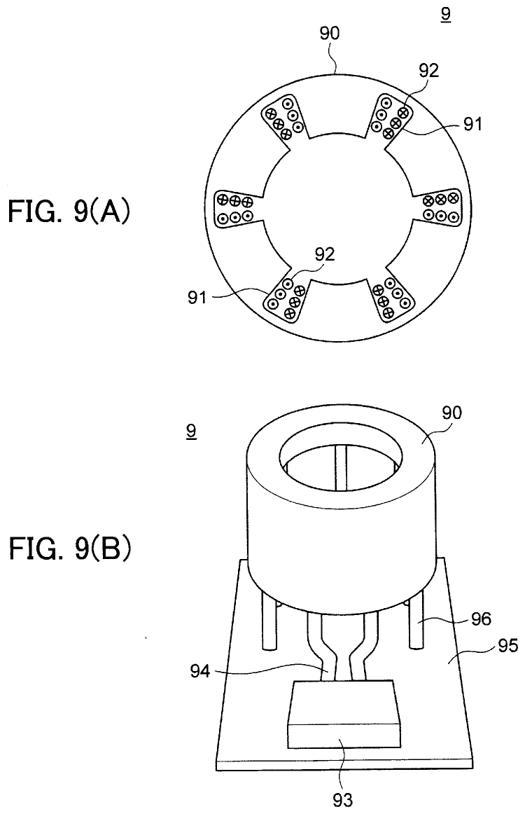

Next, Comparative Examples 1 and 2, which are compared with the first embodiment, will be described. FIG. 9(A) is a cross-sectional view illustrating a magnetizing yoke 90 of a magnetizing apparatus 9 of Comparative Example 1, and FIG. 9(B) is a diagram illustrating the entire magnetizing apparatus 9.

In the magnetizing apparatus 9 of Comparative Example 1, the permanent magnets 40 are magnetized not by the windings 20 of the stator 1, but by windings 92 of the dedicated magnetizing yoke 90. The magnetizing yoke 90 is an annular member formed of a magnetic material and has a plurality of slots 91 in the circumferential direction as illustrated in FIG. 9(A). The windings 92 are wound on the magnetizing yoke 90.

As illustrated in FIG. 9(B), the magnetizing apparatus 9 has a power supply device 93, lead wires 94 that connect the power supply device 93 and the windings 92, a base 95, and support members 96 that support the magnetizing yoke 90 on the base 95.

When the permanent magnets 40 are magnetized, the rotor 3 having the permanent magnets 40 before magnetization is placed inside the magnetizing yoke 90. By applying the magnetization current from the power supply device 93 to the windings 92, the magnetizing magnetic field is generated in the magnetizing yoke 90, thereby magnetizing the permanent magnets 40 of the rotor 3.

Since the magnetizing yoke 90 is designed exclusively for magnetizing the permanent magnets 40, the windings 92 can be made thick enough to enhance their strength. Thus, the windings 92 are less likely to be damaged even when the Lorentz force is generated by applying the magnetization current to the windings 92.

However, in the case of using the magnetizing yoke 90, a strong magnetic attractive force acts between the rotor 3 and the stator 1 when the rotor 3 is incorporated in the stator 1 after magnetizing the permanent magnets 40. Due to the magnetic attractive force, the incorporation of the rotor 3 into the stator 1 is made difficult, and the ease of assembly of the motor 100 decreases.

Further, the magnetic force of the permanent magnets 40 may cause iron powder or the like to adhere to the rotor 3. If the rotor 3 is incorporated in the stator 1 in a state where iron powder or the like adheres to the rotor 3, it may degrade the performance of the motor 100.

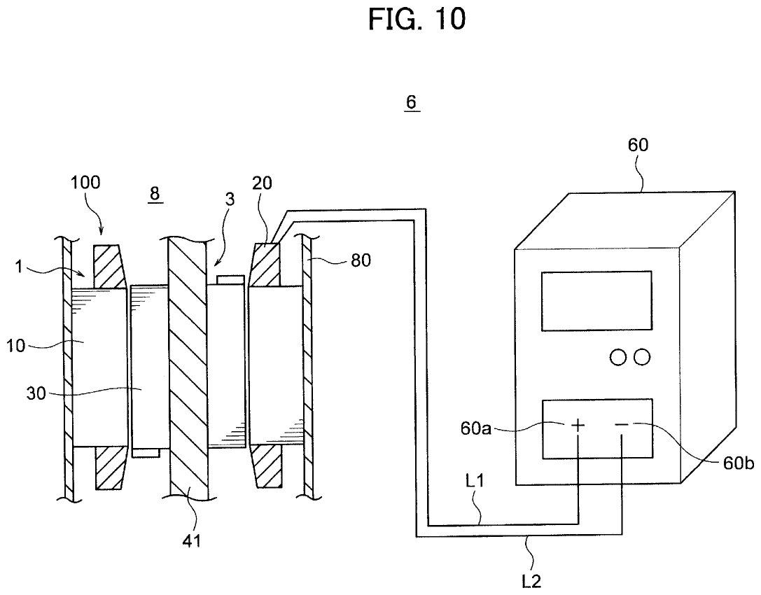

FIG. 10 is a diagram illustrating an entire magnetizing apparatus 6 of Comparative Example 2. In Comparative Example 2, the permanent magnets 40 are magnetized in a state where the motor 100 is incorporated in the compressor 8 as in the first embodiment. The magnetizing apparatus 6 of Comparative Example 2 has the power supply device 60 but does not have the outer circumferential yoke 50.

The power supply device 60 of Comparative Example 2 has the same configuration as the power supply device 60 of the first embodiment, and is connected to the windings 20 of the motor 100 via the wires L1 and L2.

Since the permanent magnets 40 are magnetized in a state where the rotor 3 is incorporated in the stator 1 in Comparative Example 2, decrease in ease of assembly and performance of the motor 100 as in Comparative Example 1 are less likely to occur. On the other hand, in Comparative Example 2, the magnetic saturation may occur within the stator core 10 during the magnetization of the permanent magnets 40.

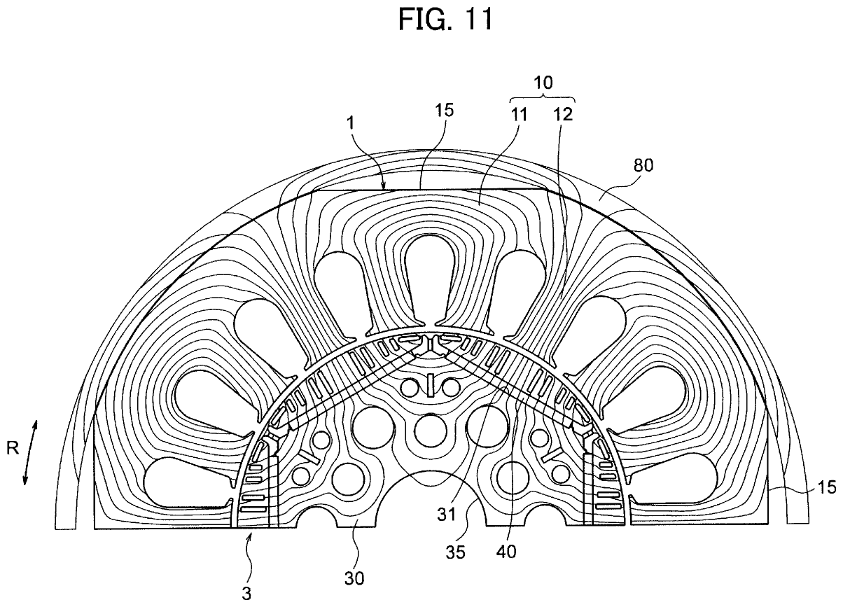

FIG. 11 is a diagram illustrating the flow of magnetic flux within the stator core 10 and the rotor core 30 during magnetization by the magnetizing apparatus 6 of Comparative Example 2. This diagram is based on a two-dimensional magnetic field analysis. A region where the magnetic flux is denser has a higher magnetic flux density. In the region with a high magnetic flux density, the magnetic saturation occurs. When the magnetic saturation occurs, the relative permittivity of the electromagnetic steel sheet decreases, and the magnetic flux is less likely to flow.

The magnetization current which is applied to the windings 20 during magnetization of the permanent magnets 40 is, for example, several kA and is greater than the current applied to the windings 20 when the motor 100 is driven. Thus, the magnetic saturation occurs notably, and the magnetizing magnetic flux is less likely to flow. As a result, the magnetization current required for the magnetization increases.

When the magnetization current increases, the Lorentz force acting between the windings 20 increases as described above with reference to FIGS. 8(A) and 8(B). Since the winding 20 of the stator 1 is thinner and has a lower strength than the winding 92 (FIG. 9(A)) of the magnetizing yoke 90, the winding 20 may be easily damaged when the Lorentz force acts on the winding 20 instantaneously.

In order to suppress magnetic saturation, it is necessary to widen a magnetic path through which the magnetizing magnetic flux flows, for example, by increasing the minimum width W1 of the core back 11 and the width W2 of the tooth 12 illustrated in FIG. 2. However, the outer diameter of the stator core 10 is limited. Thus, when the minimum width W1 of the core back 11 and the width W2 of the tooth 12 increase, the size of the slot 13 decreases, and an effective cross-sectional area of the winding 20 decreases. The decrease in effective cross-sectional area of the winding 20 leads to an increase in the copper loss of the winding 20, which lowers the motor efficiency.

### (Action)

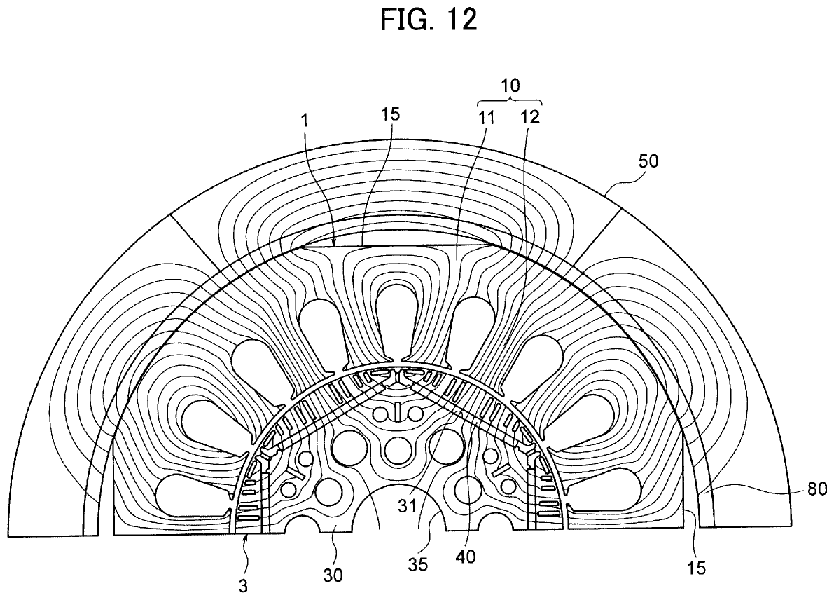

FIG. 12 is a diagram illustrating the flow of magnetic flux within the stator core 10 and the rotor core 30 during magnetization in the magnetizing apparatus 5 of the first embodiment. This diagram is based on a two-dimensional magnetic field analysis. In the magnetizing apparatus 5 of the first embodiment, the outer circumferential yoke 50 is arranged on the outer circumferential side of the stator core 10 via the compressor shell 80.

As shown in FIG. 12, the magnetic flux generated by the magnetizing magnetic field also flows to the outer circumferential yoke 50 via the compressor shell 80 formed of a magnetic material. In other words, the outer circumferential yoke 50 constitutes a part of the magnetic path. Thus, the magnetic path for the magnetizing magnetic flux can be enlarged, so that the occurrence of the magnetic saturation in the stator core 10 can be suppressed.

By suppressing the occurrence of the magnetic saturation in the stator core 10, the magnetizing magnetic flux can be efficiently guided to the permanent magnets 40. As a result, the magnetization current required to obtain the same magnetic force is reduced. Furthermore, the permanent magnets 40 can be magnetized to have a higher magnetic force with the same magnetization current.

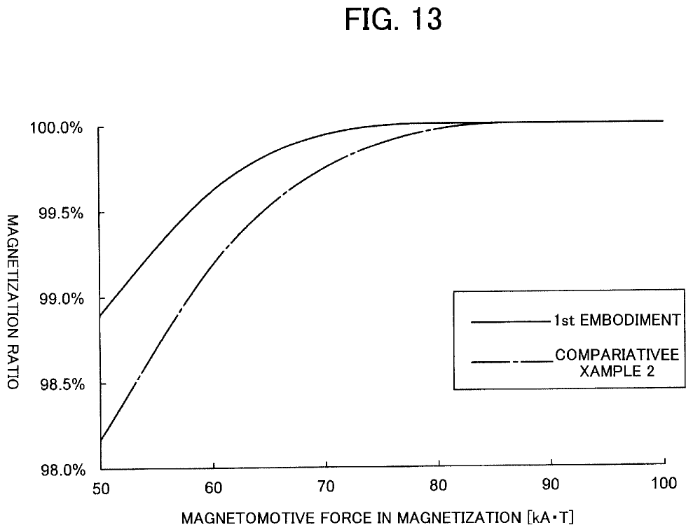

FIG. 13 is a graph illustrating the relationship between a magnetomotive force and a magnetization ratio for each of the first embodiment and Comparative Example 2. The magnetomotive force [kA·T] is the product of the current [kA] flowing in the winding 20 and the number of turns [T] of the winding 20. The magnetization ratio [%] indicates the degree of magnetization, assuming that perfect magnetization is 100%.

As can be seen from FIG. 13, in the first embodiment, the same magnetization ratio can be achieved with a smaller magnetomotive force (i.e., a smaller magnetization current), as compared to Comparative Example 2. For example, the magnetomotive force required to achieve a magnetization ratio of 99.5% is 65 [kA·T] in Comparative Example 2, but is 57.9 [kA·T] in the first embodiment. When the magnetomotive force is converted to the magnetization current [A], the magnetization current of the first embodiment is reduced by 10.9%, as compared to the magnetization current of Comparative Example 2.

Since the required magnetization current is reduced as above, the Lorentz force acting between the windings 20 is reduced, and the damage to the windings 20 can be suppressed. The Lorentz force is proportional to the square of the magnetization current. In the first embodiment, when the magnetization current is reduced by 10.9%, i.e., when the magnetization current becomes 0.89 times that of Comparative Example 2, the Lorentz force becomes 0.79 times (=0.89²) that of Comparative Example 2. That is, the Lorentz force generated in the first embodiment is reduced by 21%, as compared to the Lorentz force generated in Comparative Example 2.

Since the Lorentz force acting between the windings 20 can be reduced as above, the damage to the windings 20 can be suppressed.

The magnetic path inside the stator core 10 does not need to be widened because the outer circumferential yoke 50 serves as a part of the magnetic path for the magnetizing magnetic flux. Consequently, the slot 13 does not need to be reduced in size, and therefore the effective cross-sectional area required for the windings 20 can be secured. Thus, the reduction in the motor efficiency described above can be prevented.

In the first embodiment, the permanent magnets 40 can be magnetized in a state where the motor 100 is incorporated in the compressor 8. Thus, decrease in ease of assembly of the motor 100 as in the case of using the magnetizing yoke 90 (FIG. 9(A)) does not occur.

The outer circumferential yoke 50 is mounted to the compressor shell 80 to enlarge the magnetic path for the magnetizing magnetic flux during the magnetization of the permanent magnets 40. Then, the outer circumferential yoke 50 is detached from the compressor shell 80. Thus, the outer circumferential yoke 50 does not interfere with peripheral components, such as the refrigerant pipes of the compressor shell 80.

As is different from the magnetization external yoke described in Patent Reference 1, no winding is wound on the outer circumferential yoke 50. Thus, the outer circumferential yoke 50 can be easily mounted to and detached from the compressor shell 80 of the outer circumferential yoke 50.

### Effects of Embodiment

As described above, in the first embodiment, the outer circumferential yoke 50 made of a magnetic material is detachably mounted to the outer side of the compressor shell 80. Thus, it is possible to enlarge the magnetic path for the magnetizing magnetic flux and to suppress the occurrence of the magnetic saturation in the stator core 10. As a result, the magnetization current required to magnetize the permanent magnets 40 can be reduced, and thus damage to the winding 20 can be suppressed. That is, the reliability of the motor 100 can be improved.

Furthermore, since the magnetization current can be reduced, the capacity of the capacitor 64 of the power supply device 60 can be reduced, and the manufacturing cost of the magnetizing apparatus 5 can be reduced. After the permanent magnets 40 are magnetized, the outer circumferential yoke 50 is detached from the compressor shell 80, and thus the outer circumferential yoke 50 do not interfere with peripheral components such as the refrigerant pipes.

Since the outer circumferential yoke 50 is formed of the stacking body of the electromagnetic steel sheets, it is possible to suppress the generation of eddy current caused when the magnetizing magnetic flux flows in the outer circumferential yoke 50. Since the generation of the eddy current is suppressed, generation of heat in the outer circumferential yoke 50 can be suppressed, and the degradation of the performance of the magnetizing apparatus 5 can be suppressed.

The length of the outer circumferential yoke 50 in the axial direction is longer than or equal to the length of the stator core 10 in the axial direction, and thus the magnetizing magnetic flux is more likely to flow from the entire stator core 10 in the axial direction to the outer circumferential yoke 50. Thus, the occurrence of magnetic saturation in the stator core 10 can be suppressed more effectively.

### Second Embodiment

Next, a second embodiment will be described. FIG. 14(A) is a side view of a compressor 8 and an outer circumferential yoke 50 of the second embodiment. In FIG. 14(A), only the convex portions 86 are illustrated in cross section. FIG. 14(B) is a cross-sectional view of the compressor 8 of the second embodiment, illustrating the outer circumferential yoke 50 in a dashed line.

In the second embodiment, as illustrated in FIG. 14(A), convex portions 86 are formed as positioning portions for positioning the outer circumferential yoke 50 with respect to the compressor shell 80 of the compressor 8. The convex portions 86 abut against a lower surface of the outer circumferential yoke 50 to position the outer circumferential yoke 50 and the stator core 10 in the axial direction. The outer circumferential yoke 50 has the same configuration as the outer circumferential yoke 50 of the first embodiment.

The outer circumferential yoke 50 is mounted to the compressor shell 80 by friction with the outer circumferential surface of the compressor shell 80 as described in the first embodiment. Thus, the convex portion 86 may be any protrusion that abuts against the lower surface of the outer circumferential yoke 50. The convex portion 86 may be configured to support the outer circumferential yoke 50 from below.

As illustrated in FIG. 14(B), the plurality of convex portions 86 may be provided at equal intervals in the circumferential direction on the outer circumferential surface of the compressor shell 80. Four convex portions 86 are provided in this example, but the number of convex portions 86 only needs to be one or more. The convex portion 86 may be formed in a circular ring shape to surround the compressor shell 80.

The motor 100 cannot be recognized visually from the outside of the compressor shell 80. The provision of the convex portion 86 in the compressor shell 80 as the positioning portion facilitate the mounting operation of the outer circumferential yoke 50 to the compressor 8.

The second embodiment is the same as the first embodiment except that the convex portions 86 are provided on the compressor shell 80 of the compressor 8.

As described above, in the second embodiment, the outer circumferential yoke 50 is positioned by the convex portions 86 of the compressor shell 80. Thus, the mounting operation of the outer circumferential yoke 50 to the compressor 8 is facilitated, and the magnetizing step is facilitated.

### Third Embodiment

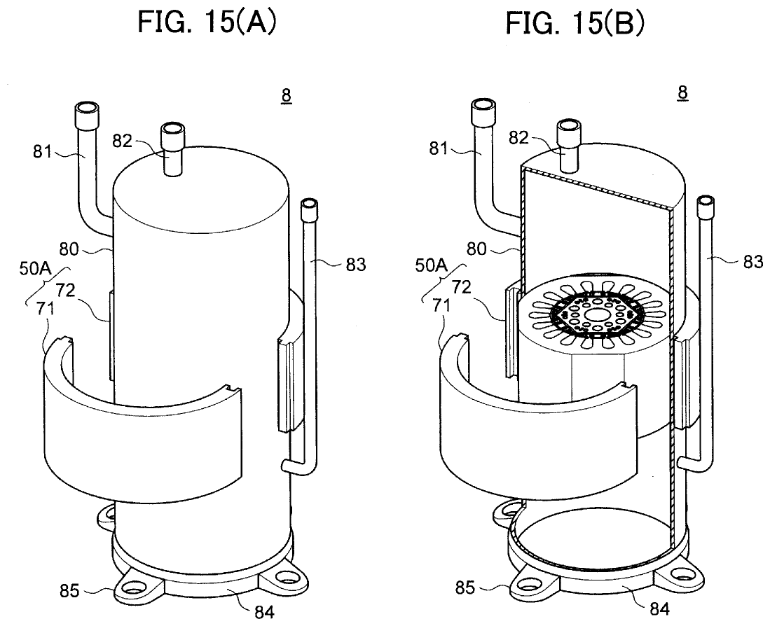

Next, a third embodiment will be described. FIG. 15(A) is a perspective view illustrating a compressor 8 and an outer circumferential yoke 50A of the third embodiment. FIG. 15(B) is a partially-sectional perspective view illustrating the compressor 8 and the outer circumferential yoke 50A of the third embodiment. The outer circumferential yoke 50 of the first embodiment is integrally configured, but the outer circumferential yoke 50A of the third embodiment is composed of a combination of two division yoke parts 71 and 72.

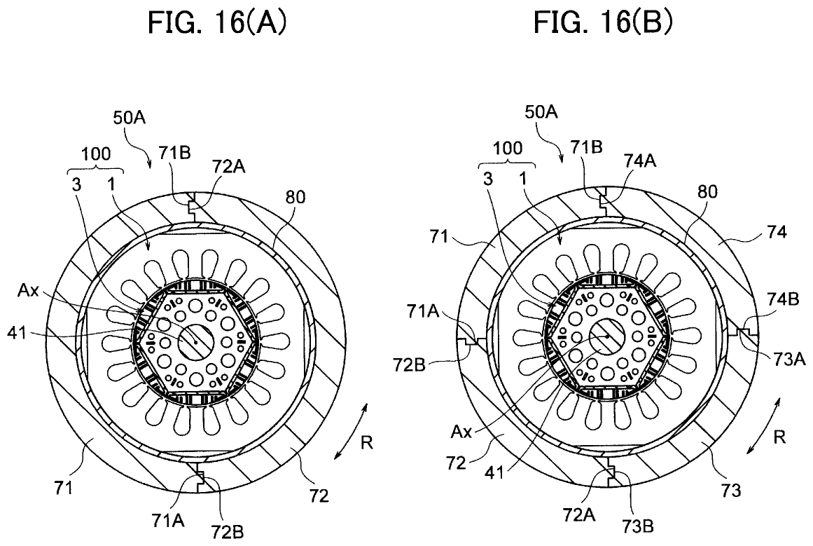

FIG. 16(A) is a cross-sectional view illustrating the compressor 8 and the outer circumferential yoke 50A. Both the division yoke parts 71 and 72 are formed in a semi-circular ring shape about the axis Ax. The division yoke part 71 has a convex portion 71A at one end thereof and a concave portion 71B at the other end thereof in the circumferential direction. The division yoke part 72 has a convex portion 72A at one end thereof and a concave portion 72B at the other end thereof in the circumferential direction.

The convex portion 71A of the division yoke part 71 engages with the concave portion 72B of the division yoke part 72, while the concave portion 71B of the division yoke part 71 engages with the convex portion 72A of the division yoke part 72. Thus, the division yoke parts 71 and 72 are combined to form the outer circumferential yoke 50A. The convex portions 71A and 72A and the concave portions 71B and 72B serve as engagement portions.

As illustrated in FIGS. 15(A) and 15(B), the division yoke parts 71 and 72 can be mounted to the compressor shell 80 from both sides to thereby form the outer circumferential yoke 50A, in a state where all the pipes 81, 82, and 83 are attached to the compressor shell 80. Thus, the outer circumferential yoke 50A can be mounted to the compressor shell 80 without interfering with the pipes 81, 82, and 83 of the compressor shell 80.

If windings are wound on the outer circumferential yoke 50A as is the case with the magnetization external yoke described in Patent Reference 1, the outer circumferential yoke 50A cannot be divided into a plurality of division yoke parts due to the presence of the windings. Since no winding is wound on the outer circumferential yoke 50A, the outer circumferential yoke 50A can be formed of the plurality of division yoke parts 71 and 72.

Although the outer circumferential yoke 50A is composed of a combination of two division yoke parts 71 and 72 in this example, three or more division yoke parts may be combined together. FIG. 16(B) illustrates an example in which four division yoke parts 71, 72, 73, and 74 are combined to form the outer circumferential yoke 50A.

Each of the division yoke parts 71, 72, 73, and 74 illustrated in FIG. 16(B) extends in the circumferential direction about the axis Ax in an angular range of 90 degrees. The convex portion 71A of the division yoke part 71 engages with the concave portion 72B of the division yoke part 72, while the convex portion 72A of the division yoke part 72 engages with a concave portion 73B of the division yoke part 73. A convex portion 73A of the division yoke part 73 engages with a concave portion 74B of the division yoke part 74, while a convex portion 74A of the division yoke part 74 engages with the concave portion 71B of the division yoke part 71.

The third embodiment is the same as the first embodiment except that the outer circumferential yoke 50A is composed of a combination of the plurality of division yoke parts 71 and 72. As in the second embodiment, the compressor shell 80 may be provided with the convex portion 86 as the positioning portion.

As described above, in the third embodiment, since the outer circumferential yoke 50A is formed of a combination of the plurality of division yoke parts 71 and 72 (or the division yoke parts 71 to 74), the outer circumferential yoke 50A can be easily mounted to the compressor shell 80 without interfering with the pipes 81, 82, and 83 even in a state where the pipes 81, 82, and 83 are attached to the compressor shell 80.

### Fourth Embodiment

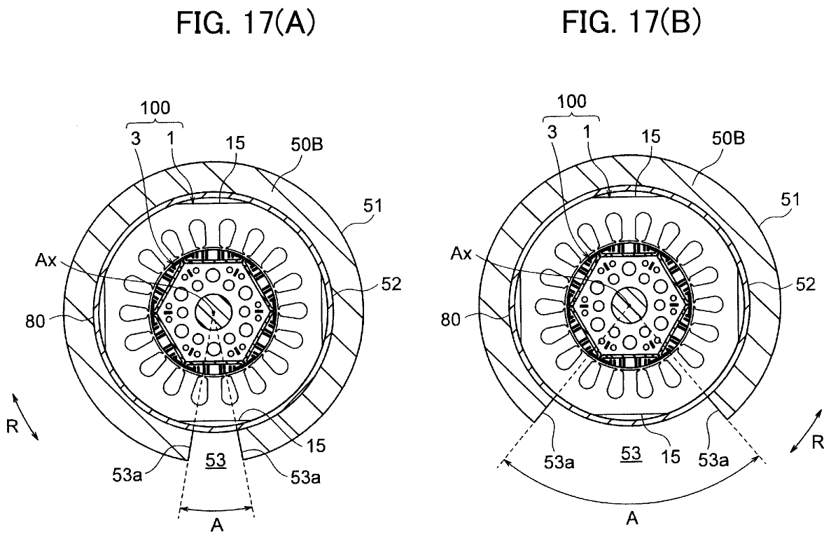

Next, a fourth embodiment will be described. FIG. 17(A) is a cross-sectional view illustrating a compressor 8 and an outer circumferential yoke 50B of the fourth embodiment. The outer circumferential yoke 50 of the first embodiment has a circular ring shape, but the outer circumferential yoke 50B of the fourth embodiment has a C shape. That is, the outer circumferential yoke 50B of the fourth embodiment has a cutout portion 53 at one location in the circumferential direction.

The outer circumferential yoke 50B has two end faces 53a that define both ends of the cutout portion 53 in the circumferential direction. The cutout portion 53 of the outer circumferential yoke 50B has an angle (referred to as a cutout angle) A about the axis Ax. The cutout angle A is an angle about the axis Ax between two end faces 53a.

In an example illustrated in FIG. 17(A), the cutout angle A is 20 degrees. In an example illustrated in FIG. 17(B), the cutout angle A is 80 degrees. The cutout portion 53 faces the D-cut portion 15 of the stator core 10 via the compressor shell 80 in the radial direction.

Since the outer circumferential yoke 50B has the cutout portion 53, the outer circumferential yoke 50B can be mounted to the compressor shell 80 so that the cutout portion 53 of the outer circumferential yoke 50B passes through the suction pipe 81. Thus, the outer circumferential yoke 50B can be mounted to the compressor shell 80 without interfering with the pipes 81, 82, and 83 in a state where all of the pipes 81, 82, and 83 are attached to the compressor shell 80.

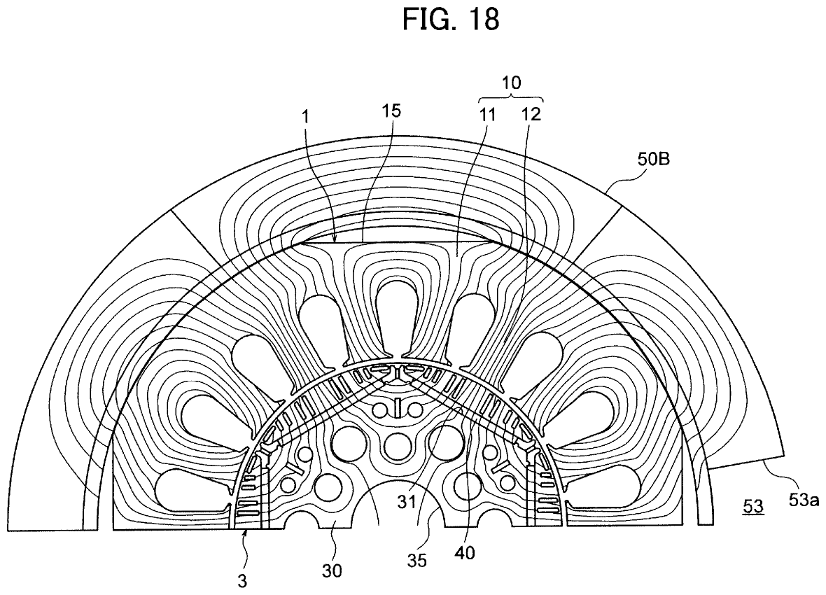

FIG. 18 is a diagram illustrating the flow of magnetic flux within the stator core 10 and the rotor core 30 during magnetization in the fourth embodiment. This diagram is based on a two-dimensional magnetic field analysis. The cutout angle A is 20 degrees in this example. The compressor shell 80 is not in contact with the D-cut portion 15 of the stator core 10, and thus the amount of magnetizing magnetic flux flowing through a portion of the compressor shell 80 facing the D-cut portion 15 is small.

For this reason, by causing the cutout portion 53 to face the D-cut portion 15 of the stator core 10 via the compressor shell 80, the influence of the cutout portion 53 on the flow of magnetic flux can be suppressed to the minimum. That is, the same effect of suppressing magnetic saturation as the circular ring-shaped outer circumferential yoke 50 can be achieved.

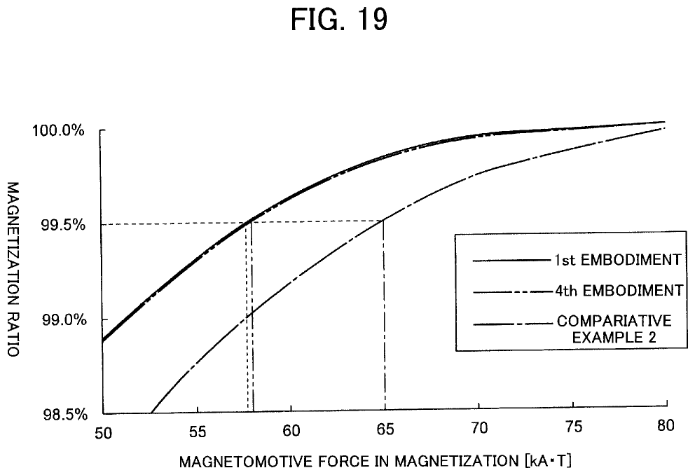

FIG. 19 is a graph illustrating the relationship between a magnetomotive force and a magnetization ratio for each of the first and fourth embodiments and Comparative Example 2. The data in the first embodiment and Comparative Example 2 are the same as those illustrated in FIG. 13. The data in the fourth embodiment is data in a case where the cutout portion 53 faces the D-cut portion 15 of the stator core 10 via the compressor shell 80 as illustrated in FIG. 18 and the cutout angle A is 20 degrees.

As can be seen from FIG. 19, the first embodiment and the fourth embodiment can achieve the same magnetization ratio with the same magnetomotive force (i.e., the same magnetization current). For example, the magnetomotive force required to achieve the magnetization ratio of 99.5% is 65 [kA·T] in Comparative Example 2 described above, but is 57.9 [kA·T] in the first embodiment and is 58.1 [kA·T] in the fourth embodiment. When the magnetomotive force is converted to the magnetization current [A], the magnetization current in the first embodiment is reduced by 10.9%, and the magnetization current in the fourth embodiment is reduced by 10.6%, as compared to the magnetization current of Comparative Example 2.

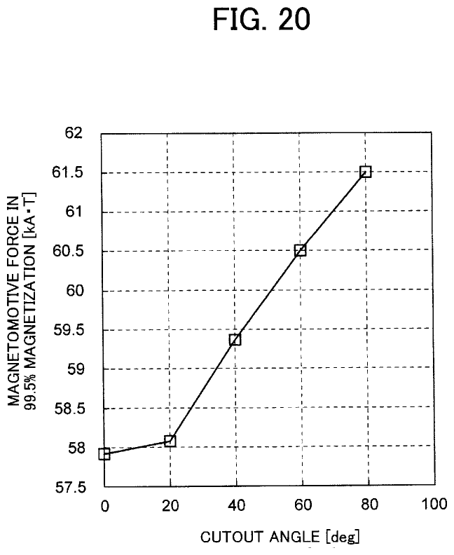

FIG. 20 is a graph illustrating the relationship between the cutout angle A [degrees] of the outer circumferential yoke 50B and a magnetomotive force [kA·T] required to achieve the magnetization ratio of 99.5% of the permanent magnet 40. The cutout portion 53 faces the D-cut portion 15 of the stator core 10 via the compressor shell 80 as illustrated in FIG. 18. The cutout angle A is changed from 0 degree to 80 degrees.

As can be seen from FIG. 20, when the cutout angle A is smaller than or equal to 20 degrees, the magnetization current required to achieve the magnetization ratio of 99.5% is small, and the ratio of the increase in the magnetization current to the increase in the cutout angle A is also small. When the cutout angle A exceeds 20 degrees, the ratio of the increase in the magnetization current to the increase in the cutout angle A becomes large. Thus, the cutout angle A is desirably smaller than or equal to 20 degrees.

Incidentally, the lower limit of the cutout angle A is an angle at which one pipe (for example, the suction pipe 81) can pass through the cutout portion 53 in the axial direction.

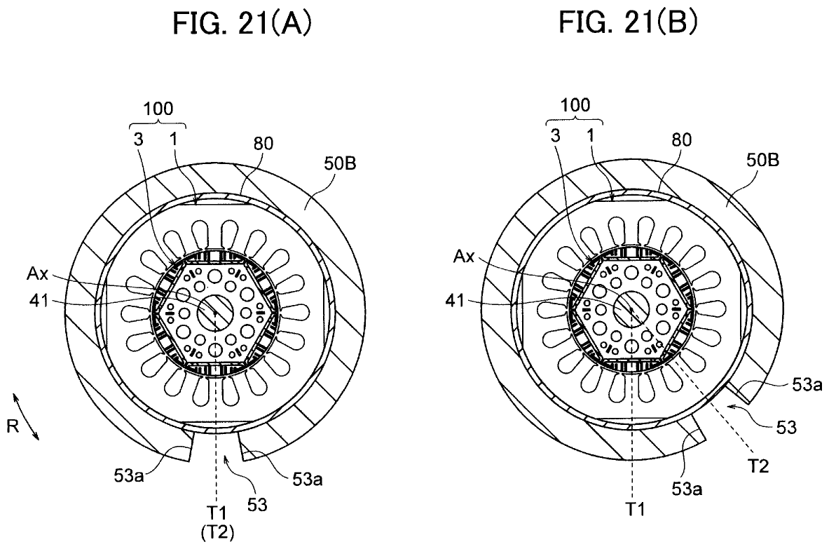

Next, the positional relationship between the cutout portion 53 of the outer circumferential yoke 50B and the D-cut portion 15 of the stator core 10 in the circumferential direction will be described. FIG. 21(A) is a diagram illustrating a state in which the center of the cutout portion 53 of the outer circumferential yoke 50B in the circumferential direction coincides with the center of the D-cut portion 15 of the stator core 10 in the circumferential direction. FIG. 21(B) is a diagram illustrating a state in which the center of the cutout portion 53 of the outer circumferential yoke 50B in the circumferential direction is displaced in the circumferential direction from the center of the D-cut portion 15 of the stator core 10 in the circumferential direction.

The straight line passing through the axis Ax and the center of the D-cut portion 15 of the stator core 10 in the circumferential direction is a first straight line T1. The straight line passing through the axis Ax and the center of the cutout portion 53 of the outer circumferential yoke 50B in the circumferential direction is a second straight line T2. An angle formed between the first straight line T1 and the second straight line T2 is referred to as a position of the cutout portion 53 in the circumferential direction, or a cutout position.

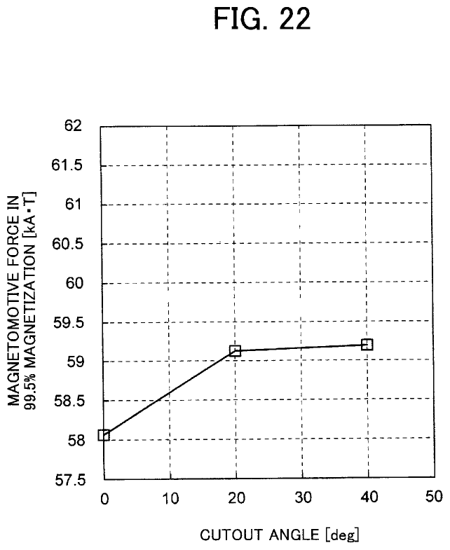

FIG. 22 is a graph illustrating the relationship between the position [degrees] of the cutout portion 53 in the circumferential direction and a magnetomotive force [kA·T] required to achieve the magnetization ratio of 99.5% in the permanent magnet 40.

As can be seen from FIG. 22, when the position of the cutout portion 53 in the circumferential direction is 20 degrees or below, the magnetization current required to achieve the magnetization ratio of 99.5% is small, and the ratio of the increase in the magnetization current to the increase in the position of the cutout portion 53 in the circumferential direction is also small. Thus, the position of the cutout portion 53 in the circumferential direction is desirably 20 degrees or below.

However, the influence of the position of the cutout portion 53 in the circumferential direction on the magnetization current is smaller than that of the cutout angle illustrated in FIG. 20. Thus, the position of the cutout portion 53 in the circumferential direction may exceed 20 degrees.

The fourth embodiment is the same as the first embodiment except that the outer circumferential yoke 50B has a C shape. As described in the second embodiment, the compressor shell 80 may be provided with the convex portion 86 as the positioning portion. As descried in the third embodiment, the C-shaped outer circumferential yoke 50B may be formed of a combination of a plurality of division yoke parts.

As described above, in the fourth embodiment, since the outer circumferential yoke 50B has the cutout portion 53, the outer circumferential yoke 50B can be easily mounted to the compressor shell 80 without interfering with the pipes 81, 82, and 83 even in a state where all of the pipes 81, 82, and 83 are attached to the compressor shell 80.

Further, since the cutout angle A of the cutout portion 53 is smaller than or equal to 20 degrees, the magnetization current required to achieve a certain magnetization ratio can be made small, and thus damage to the windings 20 can be suppressed.

In addition, since the position of the cutout portion 53 in the circumferential direction with respect to the D-cut portion 15 of the stator core 10 is 20 degrees or below, the magnetization current required to achieve a certain magnetization ratio can be made small, and thus damage to the winding 20 can be suppressed.

### (Demagnetizing Apparatus)

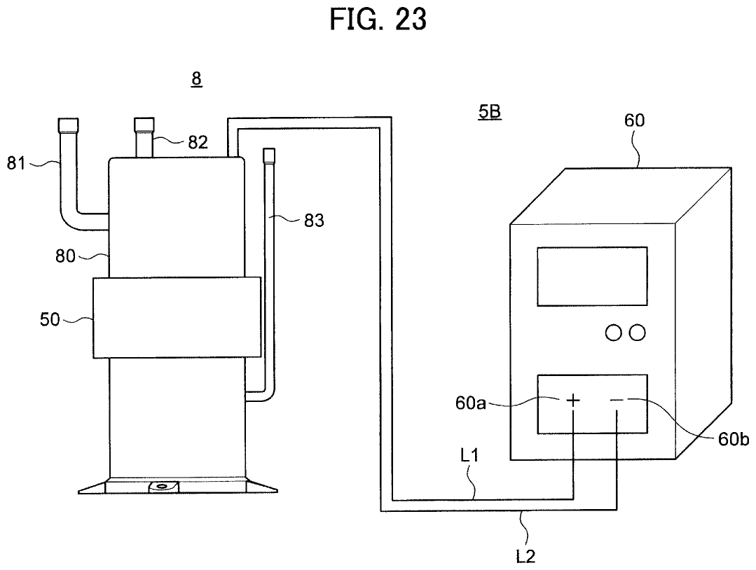

Next, an example of using the magnetizing apparatus of each embodiment as a demagnetizing apparatus will be described. FIG. 23 is a diagram illustrating a demagnetizing apparatus 5B for demagnetizing the motor 100 incorporated in the used compressor 8. The demagnetizing apparatus 5B has the outer circumferential yoke 50 mounted to the compressor 8 and the power supply device 60.

The configurations of the outer circumferential yoke 50 and the power supply device 60 are as described in the first embodiment. The terminals 60a and 60b of the power supply device 60 are connected to the windings 20 of the motor 100 via the wires L1 and L2. The compressor 8 is as described in the first embodiment except that the compressor 8 is a used one.

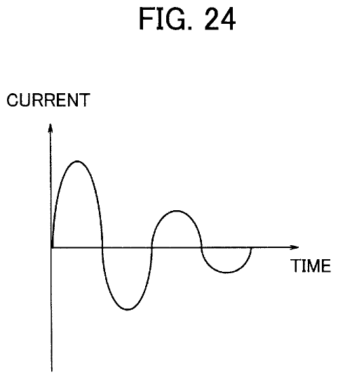

FIG. 24 illustrates the demagnetization current that is applied from the power supply device 60 to the windings 20 of the motor 100. The demagnetization current has a waveform with a gradually decreasing amplitude. The demagnetization current is applied to the windings 20 to thereby gradually weaken the magnetic force of the permanent magnets 40 and demagnetize the permanent magnets 40. After the permanent magnets 40 are demagnetized, the compressor 8 is disassembled, and the motor 100 is disassembled. Reusable parts are reused.

The demagnetization current has a significant peak current at the start of application. The occurrence of the magnetic saturation in the stator core 10 can be suppressed by causing part of a demagnetizing magnetic flux to flow in the outer circumferential yoke 50. As a result, the demagnetization current required for demagnetization is reduced. Thus, it is possible to reduce the capacity of the capacitor 64 and to reduce the manufacturing cost of the power supply device 60.

In the demagnetizing apparatus 5B illustrated in FIG. 23, the outer circumferential yokes 50A and 50B described in the third and fourth embodiments may be used. As described in the second embodiment, a positioning portion may be provided on the outer circumference of the compressor shell 80.

### (Compressor)

Next, a compressor 300 to which the motor described in each of the above-described embodiments is applicable will be described. FIG. 25 is a cross-sectional view illustrating the compressor 300. The compressor 300 is a scroll compressor in this example, but is not limited thereto.

The compressor 300 includes a compressor shell 307, a compression mechanism 305 arranged in the compressor shell 307, the motor 100 that drives the compression mechanism 305, a shaft 41 connecting the compression mechanism 305 and the motor 100, and a subframe 308 that supports a lower end of the shaft 41.

The compression mechanism 305 includes a fixed scroll 301 having a spiral portion, a swing scroll 302 having a spiral portion forming a compression chamber between the spiral portions of the fixed scroll 301 and the swing scroll 302, a compliance frame 303 that holds an upper end of the shaft 41, and a guide frame 304 that is fixed to the compressor shell 307 and holds the compliance frame 303.

A suction pipe 310 that penetrates the compressor shell 307 is press-fitted into the fixed scroll 301. The compressor shell 307 is provided with a discharge pipe 311 through which a high-pressure refrigerant gas discharged from the fixed scroll 301 is discharged to the outside. The discharge pipe 311 communicates with an opening (not shown) provided in the compressor shell 307 between the compression mechanism 305 and the motor 100.

The motor 100 is fixed to the compressor shell 307 by fitting the stator 1 into the compressor shell 307. The configuration of the motor 100 is as described above. A glass terminal 309 for supplying electric power to the motor 100 is fixed by welding to the compressor shell 307. The wires L1 and L2 illustrated in FIG. 3 are connected to the glass terminal 309.

When the motor 100 rotates, the rotation of the motor 100 is transmitted to the swing scroll 302, and causes the swing scroll 302 to swing. As the swing scroll 302 swings, the volume of the compression chamber formed by the spiral portions of the swing scroll 302 and the fixed scroll 301 changes. Then, the refrigerant gas is sucked through the suction pipe 310, compressed, and discharged through the discharge pipe 311.

The compressor shell 307 corresponds to the compressor shell 80 (FIG. 6(A)) described in the first embodiment. The suction pipe 310 and the discharge pipe 311 correspond to the suction pipe 81 and the discharge pipe 82 (FIG. 6(A)) described in the first embodiment, respectively. The pipe corresponding to the oil pipe 83 is not illustrated in FIG. 25.

The motor 100 of the compressor 300 has high reliability due to the suppression of damage to the windings 20. Thus, the reliability of the compressor 300 can be improved.

### (Refrigeration Cycle Apparatus)

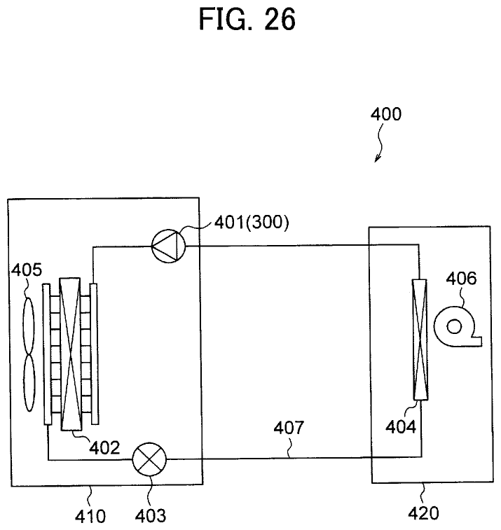

Next, a refrigeration cycle apparatus 400 having the compressor 300 illustrated in FIG. 25 will be described. FIG. 26 is a diagram illustrating the refrigeration cycle apparatus 400. The refrigeration cycle apparatus 400 is, for example, an air conditioner in this example, but is not limited to thereto.

The refrigeration cycle apparatus 400 illustrated in FIG. 26 includes a compressor 401, a condenser 402 to condense a refrigerant, a decompression device 403 to decompress the refrigerant, and an evaporator 404 to evaporate the refrigerant. The compressor 401, the condenser 402, and the decompression device 403 are provided in an indoor unit 410, and the evaporator 404 is provided in an outdoor unit 420.

The compressor 401, the condenser 402, the decompression device 403, and the evaporator 404 are connected by a refrigerant pipe 407 to constitute a refrigerant circuit. The compressor 401 is constituted by the compressor 300 illustrated in FIG. 25. The refrigeration cycle apparatus 400 includes an outdoor fan 405 facing the condenser 402 and an indoor fan 406 facing the evaporator 404.

The operation of the refrigeration cycle apparatus 400 is as follows. The compressor 401 compresses the sucked refrigerant and discharges the compressed refrigerant as a high-temperature and high-pressure refrigerant gas. The condenser 402 exchanges heat between the refrigerant discharged from the compressor 401 and the outdoor air supplied by the outdoor fan 405 to condense the refrigerant and discharges the condensed refrigerant as a liquid refrigerant. The decompression device 403 expands the liquid refrigerant discharged from the condenser 402 and discharges the expanded refrigerant as a low-temperature and low-pressure liquid refrigerant.

The evaporator 404 exchanges heat between the low-temperature and low-pressure liquid refrigerant discharged from the decompression device 403 and the indoor air to evaporate (vaporize) the refrigerant and discharges the evaporated refrigerant as a refrigerant gas. Thus, air from which the heat is removed in the evaporator 404 is supplied by the indoor fan 406 to the interior of a room, which is a space to be air-conditioned.

The motor 100 described in each embodiment is applicable to the compressor 401 in the refrigeration cycle apparatus 400. As the motor 100 has high reliability due to the suppression of damage to the windings 20, the reliability of the refrigeration cycle apparatus 400 can be enhanced.

Although the desirable embodiments have been specifically described above, the present disclosure is not limited to the above embodiments, and various modifications and changes can be made to those embodiments.

1. A magnetizing apparatus to magnetize a permanent magnet of a motor,
the motor comprising an annular stator mounted to an inner side of a compressor shell and having a winding, and a rotor provided on an inner side of the stator and having the permanent magnet,
the magnetizing apparatus comprising:
an outer circumferential yoke detachably mounted to an outer side of the compressor shell and being made of a magnetic material; and
a power supply device to apply a magnetization current to the winding of the stator,
wherein the outer circumferential yoke is shaped to surround the compressor shell, and has a cutout portion at one location in a circumferential direction about a rotation axis of the rotor.

2. The magnetizing apparatus according to claim 1, wherein the outer circumferential yoke is formed of a stacking body of electromagnetic steel sheets.

3. The magnetizing apparatus according to claim 1, wherein the stator has a stator core on which the winding is wound, and
wherein, when a direction of the rotation axis of the rotor is defined as an axial direction, a length of the outer circumferential yoke in the axial direction is longer than or equal to a length of the stator core in the axial direction.

4. The magnetizing apparatus according to claim 1, wherein the outer circumferential yoke is positioned by a positioning portion provided on an outer circumferential surface of the compressor shell.

5. The magnetizing apparatus according to claim 1, wherein the outer circumferential yoke is divided into two or more division yoke parts in the circumferential direction.

6. The magnetizing apparatus according to claim 5, wherein the two or more division yoke parts have engagement portions that engage with each other.

7. (canceled)

8. The magnetizing apparatus according to claim 1, wherein an angular range of the cutout portion about the rotation axis is smaller than or equal to 20 degrees.

9. The magnetizing apparatus according to claim 8, wherein the stator has a planer portion at an outer circumference thereof, and
wherein the cutout portion faces the planer portion of the stator via the compressor shell in a radial direction about the rotation axis.

10. The magnetizing apparatus according to claim 9, wherein an angle formed between a first straight line passing through the rotation axis and a center of the planer portion of the stator in the circumferential direction and a second straight line passing through the rotation axis and a center of the cutout portion in the circumferential direction is smaller than or equal to 20 degrees.

11. The magnetizing apparatus according to claim 1, wherein the permanent magnet is demagnetized by applying a demagnetization current from the power supply device to the winding of the stator, during demagnetization of the permanent magnet.

12. A magnetizing method of magnetizing a permanent magnet of a motor,
the motor comprising an annular stator mounted to an inner side of a compressor shell and having a winding, and a rotor provided on an inner side of the stator and having the permanent magnet,
the magnetizing method comprising:
mounting an outer circumferential yoke made of a magnetic material to an outer side of the compressor shell;
applying a magnetization current from a power supply device to the winding of the stator; and
detaching the outer circumferential yoke from the compressor shell,
wherein the outer circumferential yoke is shaped to surround the compressor shell, and has a cutout portion at one location in a circumferential direction about a rotation axis of the rotor.

13. The magnetizing method according to claim 12, wherein, in the step of mounting the outer circumferential yoke, the outer circumferential yoke is positioned by a positioning portion provided on an outer circumferential surface of the compressor shell.

14. The magnetizing method according to claim 12, wherein, in the step of mounting the outer circumferential yoke, two or more division yoke parts are combined to form the outer circumferential yoke.

15. The magnetizing method according to claim 12,
wherein the outer circumferential yoke has a cutout portion at one location in a circumferential direction about a rotation axis of the rotor, and
wherein, in the step of mounting the outer circumferential yoke, the outer circumferential yoke is mounted to the compressor shell so that the cutout portion passes through a pipe provided on the compressor shell.

16. A rotor of a motor,
the motor comprising an annular stator mounted to an inner side of a compressor shell and having a winding, and the rotor provided on an inner side of the stator and having the permanent magnet,
the permanent magnet being magnetized by:
mounting an outer circumferential yoke made of a magnetic material to an outer side of the compressor shell;
applying a magnetization current from a power supply device to the winding of the stator; and
detaching the outer circumferential yoke from the compressor shell,
wherein the outer circumferential yoke is shaped to surround the compressor shell, and has a cutout portion at one location in a circumferential direction about a rotation axis of the rotor.

17. A motor comprising the rotor according to claim 16 and the stator.

18. A compressor comprising:
the motor according to claim 17;
a compression mechanism driven by the motor; and
a compressor shell in which the motor and the compression mechanism are housed.

19. The compressor according to claim 18, wherein a positioning portion for positioning the outer circumferential yoke is provided at an outer circumferential surface of the compressor shell.

20. A refrigeration cycle apparatus comprising the compressor according to claim 18, a condenser, a decompressor, and an evaporator.
